(19) United States
(12) Patent Application Publication
(10) Pub. No.: US 2015/0229886 A1
(43) Pub. Date: Aug. 13, 2015

(54) APPARATUS FOR SHARING MULTIMEDIA DATA IN REALTIME WIRELESS MANNER FOR THE PURPOSE OF EXTENDING VISION

(71) Applicant: MtoV Inc., Daejeon (KR)

(72) Inventors: Sangsu JUNG, Uiwang-si (KR); Eunjung Lee, Uiwang-si (KR)

(21) Appl. No.: 14/617,026

(22) Filed: Feb. 9, 2015

(30) Foreign Application Priority Data
Feb. 7, 2014 (KR) 10-2014-0014280

(51) Int. Cl. H04N 7/18; B60R 1/00

(52) U.S. Cl. CPC H04N 7/181; B60R 1/00; B60R 2300/105; B60R 2300/303; B60R 2300/50; B60R 2300/80

(57) ABSTRACT

The present disclosure relates to apparatus for sharing network multimedia data in realtime wireless manner for the purpose of extending vision. The apparatus for sharing network multimedia data in realtime wireless manner for the purpose of extending vision in accordance with one exemplary embodiment of the present invention includes a plurality of first camera modules which take the image of outside condition around the first vehicle; a first display module that displays one or more of images among multiple own images taken by the multiple first camera module; and a first communication module that is connected on a mobile ad hoc network and transmits the own image to multiple second communication modules connected on the same mobile ad hoc network, wherein the first communication module receives first outside images from the multiple second communication modules and the first display module further displays the outside images.

### CROSS-REFERENCE TO RELATED APPLICATION

This application claims the priority of the Korean Patent Application No. 10-2014-0014280 filed on Feb. 7, 2014 in the Korean Intellectual Property Office, and all the benefits accruing therefrom under 35 U.S.C. §119, the contents of which in their entirety are herein incorporated by reference.

### TECHNICAL FIELD

The present invention relates to apparatus for sharing multimedia data in realtime wireless manner for the purpose of extending vision, and more particularly, to apparatus for sharing multimedia data generated in a vehicle with a surrounding vehicle in realtime by using a mobile ad hoc network.

### BACKGROUND ART

A mobile ad hoc network refers to a network which is self-organized by wireless nodes without any infrastructure such as a base station or cable. Mobile ad hoc nodes transceive data by using wireless interface, and the network topology changes dynamically. Its application field includes vehicular networks, military networks, and temporary public networks.

The conventional art for sharing multimedia data is intended for a system for transmitting multimedia data, which is immovable, such as CCTV, and the transmitted image is displayed on an immovable output device by wire or wireless.

For the data management technology linked with mobile network, there is a content delivery network or a disruption-tolerant network, wherein the data are cached to a certain level, and then directly transmitted wirelessly upon request.

### DISCLOSURE OF INVENTION

### Technical Problem

The conventional apparatus for sharing multimedia data, wherein mobile ad hoc network is implemented, cannot provide a user-level realtime service because it is not designed to be suitable for delay-sensitive traffic of images. Particularly, it sets up a plurality of unspecified nodes in a same network group, incurring data competition for transmission, thereby deteriorating performance due to frequent loss of data packet and prolonged waiting time.

The conventional image collecting apparatus cannot take a picture of the shape or condition of itself, exposed to danger, directly by a camera unit, due to limited directions to take a picture with (the front and the rear). And there are spots, including a blind spot, which cannot be taken due to a limited distance (range) to take a picture from.

The conventional apparatus for sharing multimedia data takes a picture in a fixed state, and then transmits the data over wired network, which has a stable channel condition and wide bandwidth, to be displayed on an outputting device in a fixed state. Accordingly, when the mobility is taken into account, it is impossible to provide a user-level service due to unstable channel condition and relatively low bandwidth. Moreover, a method of collecting and outputting images by mobile apparatus is absent.

The present invention is to resolve the aforementioned technical issue by providing apparatus for sharing multimedia data in realtime wireless manner for the purpose of extending vision, where the image collecting apparatus placed inside a vehicle takes images from diverse angles and the multimedia data are displayed selectively to provide extended vision.

The present invention, in order to resolve another technical issue, is to provide apparatus for sharing multimedia data in realtime wireless manner for the purpose of extending vision, which, by combining a plurality of images received from the outside, enables monitoring in three-dimensions all the images not only of the apparatus's own shape and condition but also taken from a long distance, in obstacle zone, and in a blind spot, which are impossible to be captured by the camera unit of the own apparatus.

To resolve another technical issue, the present invention is to provide apparatus for sharing network multimedia data in realtime wireless manner for the purpose of extending vision, which shares collected multimedia data in realtime by connecting mobile apparatus collecting multimedia data to a mobile ad hoc network.

To resolve another technical issue, the present invention is to provide apparatus for sharing network multimedia data in realtime wireless manner for the purpose of extending vision, which enables sharing of multimedia data by including a limited number of mobile apparatus in a specific direction, as a node, to a mobile ad hoc network, in order to form a mobile ad hoc network group composed of mobile apparatus collecting multimedia data.

To resolve a further technical issue, the present invention is to provide apparatus for sharing network multimedia data in realtime wireless manner for the purpose of extending vision, which collects, encrypts, and transmits the related multimedia data in order to prevent data loss and to respond to an emergency, when a significant impact such as a car accident is applied onto wireless apparatus for sharing multi-image.

The technical issues the present invention is to resolve are not limited to the above mentioned, but other issues not mentioned herein will be clearly understandable for those having ordinary skill in the art upon description which follows.

### Technical Solution

In order to resolve the aforementioned technical issues, the apparatus for sharing network multimedia data in realtime wireless manner for the purpose of extending vision in accordance with one exemplary embodiment of the present invention includes a plurality of first camera modules that take a picture of outside condition around the first vehicle, a first display module that displays one or more images among multiple own images taken by the plurality of first camera modules, and a first communication module that is connected over a mobile ad hoc network and transmits the own image to a plurality of second communication modules connected on the same mobile ad hoc network. The above first communication module receives a first outside image from the above plurality of second communication modules and the above first display module further displays the above outside images.

The first outside images are taken by the second camera module placed in a second vehicle that is located within the range of the same mobile ad hoc network and the second vehicle may include the second communication module and the second display module.

The first outside images include multiple images of the first vehicle taken from different angles and the first display module further displays a monitoring image of the entire exterior of the first vehicle by combining the multiple vehicle images.

The first display module further displays the second outside images that are taken outside the range of the same mobile ad hoc network and the second outside images can be received on the first communication module via external network.

In the event that a sensor module that detects the amount of impact applied onto the first vehicle and the aforementioned sensor module detect impact, an event management portion that generates event data at the time of an accident may further be included.

### Advantageous Effects

The present invention mentioned above has various effects as in the following.

First, the apparatus for sharing network multimedia data in realtime wireless manner for the purpose of extending vision in accordance with the exemplary embodiments of the present invention enables obtainment of multimedia data with extended vision because the image collecting apparatus placed inside a vehicle takes pictures of circumstances surrounding the vehicle from diverse angles via multiple camera units and displays all or selected multiple image data transmitted from each of the multiple camera units.

Second, the apparatus for sharing network multimedia data in realtime wireless manner for the purpose of extending vision in accordance with the exemplary embodiments of the present invention enables monitoring of host apparatus in three dimensions by providing the images acquired from the host apparatus, combined with the images of the host apparatus taken from the outside from different angles. In particular, such images taken from the outside are useful for grasping the condition of a blind spot and extending a range of vision because it is restrictive for the host apparatus to take a picture of itself.

Third, the system for sharing network multimedia data in realtime wireless manner for the purpose of extending vision in accordance with the exemplary embodiments of the present invention enables preparing for the dangers by checking for the image taken from the outside of a risk factor at long range, which is not seen from the host apparatus. That is, since a person in the host vehicle can detect risk factors beforehand by monitoring the images taken of the outside of the other vehicle, adjacent to the host vehicle, such as a front image of the front vehicle or a rear image of the rear vehicle which are not visible to the person in the host vehicle.

Forth, the system for sharing network multimedia data in realtime wireless manner for the purpose of extending vision in accordance with the exemplary embodiments of the present invention has an advantage of providing a user-level service for sharing network multimedia data in realtime by limiting the number of the apparatus for transmitting multimedia data, as a node being included in a mobile ad hoc network composed of a single subnet.

Fifth, the system for sharing network multimedia data in realtime wireless manner for the purpose of extending vision in accordance with the exemplary embodiments of the present invention enables dual storage management of important data because it transmits the frames taken by itself to adjacent wireless apparatus for transmitting multi-image in realtime, and the wireless apparatus for transmitting multi-image directly saves the transmitted frames.

Sixth, the apparatus for sharing network multimedia data in realtime wireless manner for the purpose of extending vision in accordance with the exemplary embodiments of the present invention solves the problem regarding the protection of information by encrypting and saving the data to send out to a base station, and by allowing only those concerned and identified to access the sensitive data when receiving multimedia data taken of a special circumstance, such as a car accident.

### BRIEF DESCRIPTION OF DRAWINGS

FIG. 1 is a block diagram illustrating an outline of the apparatus for sharing network multimedia data in realtime wireless manner for the purpose of extending vision in accordance with one exemplary embodiment of the present invention.

FIGS. 2 through 4 are diagrams illustrating one exemplary embodiment of the present invention, wherein the apparatus for sharing network multimedia data in realtime wireless manner for the purpose of extending vision of FIG. 1 is applied.

FIG. 5 is a flow chart that explains a method to form a mobile ad hoc network group among pieces of apparatus for sharing network multimedia data in realtime wireless manner for the purpose of extending vision in accordance with another exemplary embodiment of the present invention.

FIG. 6 is a diagram illustrating the relationship among a plurality of apparatus to which the mobile ad hoc network of FIG. 5 is applied.

FIGS. 7 through 11 are diagrams illustrating a process of sharing multimedia data in realtime when apparatus for sharing network multimedia data in realtime wireless manner for the purpose of extending vision in accordance with exemplary embodiments of the present invention is colliding with each other.

### BEST MODE FOR CARRYING OUT THE INVENTION

A desirable exemplary embodiment of the present invention will be described in detail hereinafter in reference with the accompanied drawings. The advantage and characteristic, and a method to achieve them will be obvious upon detailed description of the exemplary embodiments as well as accompanied drawings which follow. However, the present invention is not limited to the exemplary embodiments set forth herein, but can be embodied in many different forms. The exemplary embodiments are provided only to render the present disclosure complete and the scope of the present invention comprehensible to those having ordinary skill in the art. The present invention is only to be defined by the claims. A reference mark used refers to a same element throughout the description.

Without separate definitions, all terms (including technical and scientific terms) used in the present description may be used for the meanings commonly understandable for those having ordinary skill in the art. In addition, the terms generally used and having definitions in dictionary, unless otherwise defined obviously in particular, should not be ideally or exaggeratedly interpreted.

The terms used in the present description are to explain the exemplary embodiments, not to limit the present invention thereto. In the present description, a singular form of word also includes a plural form thereof unless otherwise noted. The term “comprises” and/or “comprising” is not excluding the meaning that one or more elements other than the said element may exist or be added.

The apparatus for sharing network multimedia data in realtime wireless manner for the purpose of extending vision in accordance with the exemplary embodiments of the present invention will be described in reference with the drawings as in the following.

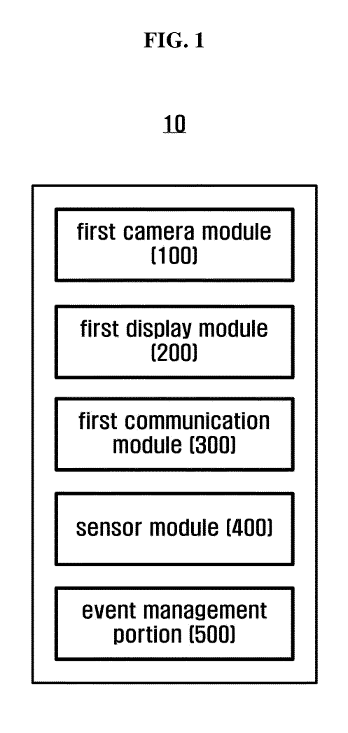

The FIG. 1 shows the overall composition of the apparatus for sharing network multimedia data in realtime wireless manner for the purpose of extending vision in accordance with one exemplary embodiment of the present invention. The apparatus for sharing network multimedia data in realtime wireless manner for the purpose of extending vision (10) in accordance with exemplary embodiments of the present invention includes a plurality of first camera modules (100) that take pictures of outside circumstances around the first vehicle, a first display module (200) that displays one or more images among multiple own images taken by the plurality of first camera modules (100), and a first communication module (300) that is connected on a mobile ad hoc network and transmits the own image to a plurality of second communication modules that are connected on the same mobile ad hoc network. The first communication module (300) receives a first outside image from the plurality of second communication modules and the first display module (200) further displays the outside images.

In this exemplary embodiment, the first apparatus and the second apparatus refer to various kinds, including mobile apparatus mutually transmitting data, connected on the network, or the various means equipped with such mobile apparatus, while not limited thereto. The first apparatus may refer to the apparatus for sharing network multimedia data in realtime wireless manner for the purpose of extending vision (10) in accordance with exemplary embodiments of the present invention and the second apparatus may refer to the apparatus for sharing network multimedia data in realtime wireless manner for the purpose of extending vision, having the same configuration as the first apparatus but being placed at a short distance away from the first apparatus. In addition, the first apparatus and the second apparatus may include a driving gear such as a vehicle, and a remote control driving gear, but the kind of apparatus is not limited thereto.

The apparatus for sharing network multimedia data in realtime wireless manner for the purpose of extending vision (10) in accordance with one exemplary embodiment of the present invention may be placed or embedded inside a vehicle and may include mobile apparatus or various methods equipped with such mobile apparatus connected on the network and transmitting data but the kind of apparatus is not limited thereto.

The first camera module (100) is placed in the apparatus for sharing network multimedia data in realtime wireless manner for the purpose of extending vision (10) in accordance with one exemplary embodiment of the present invention and the first camera module (100) may include a plurality of camera modules. As the plurality of the first camera module (100) that can take images from different angles such as the left and right sides or the front and rear areas of a vehicle are placed at a certain distance away from each other, the person inside the vehicle can collect own images of outside condition with extended vision.

The first display module (200) displays images taken by the plurality of first camera modules and may display all of multimedia data (own images) or selectively display one or more own images.

In several other exemplary embodiments, the first display module (200) may include a plurality of display modules on which maps each image source one by one, and display a plurality of images on divided screens of one display module (200). For example, the first display module (200) can display the front and rear images of the vehicle at the same time and additionally, display the second front or rear images of the vehicle at the same time.

Own images may include the data about the areas surrounding a vehicle equipped with the apparatus for sharing network multimedia data in realtime wireless manner for the purpose of extending vision (10) in accordance with exemplary embodiments of the present invention, for example, the images of surrounding roads, geographical features, distribution or location of surrounding vehicles or apparatus that exist on the same network.

The first communication module (300) can be connected on a mobile ad hoc network to the plurality of second communication modules that are located within a prescribed radius from the first communication module (300) and share multimedia data, for example, images, the status of each other, and vision with several second communication modules that are connected on the same mobile ad hoc network.

The second communication module may be placed in multiple second vehicles located around the first vehicle, where the first image sharing apparatus (10) including the first communication module (300) is placed, and the second vehicle may further have the second image sharing apparatus including more second camera modules and second display modules.

The first communication module (300) can transmit own images taken by the first camera module (100) to the second communication module and likewise, receive outside images taken by the second camera module from the second communication module.

The outside images may include multiple outside images received from multiple second communication modules, for example, images of the first vehicle taken at a specific angle by multiple second vehicles around the first vehicle.

In several other exemplary embodiments, outside images may include at least one image from the group of images taken from the front, rear, left and right sides of the second vehicle and such outside images may be received from a plurality of different second communication modules. For example, in case the second communication module transmitting outside images is located at the back of the first communication module (300) or the first vehicle, the second camera module takes pictures of the images from the front, rear, left, and right sides and transmits the images to the first communication module (300) in realtime. Although the first vehicle cannot recognize the condition at the rear of the second vehicle behind the first vehicle due to a restrictive vision, sharing of the rear image from the second vehicle with the first vehicle enables the first vehicle to recognize the condition at the rear of the second vehicle as well as that of its own.

Thus, when a plurality of second communication modules exist and receive multiple outside images from the apparatus around the first vehicle, the various images from a range, to which the first vehicle cannot recognize, can be obtained.

In addition, the host apparatus (10) and its surrounding apparatus are connected on the same mobile ad hoc network, and own images taken by the first apparatus (10) and the outside image taken by the plurality of second apparatus can be shared with each other over the mobile ad hoc network.

In the present exemplary embodiment, the number of apparatus which is shared with each other over a mobile ad hoc network is restrictive. For example, a network can be composed of the first apparatus (10), as host apparatus, one piece of second apparatus located in front of the first apparatus, and two pieces of the third apparatus (having the same composition as that of the second apparatus) located in the rear of the first apparatus, however, a composition is not limited thereto. The apparatus located on the side of the first apparatus (10) or at a specific angle from the first apparatus can be selectively connected to a mobile ad hoc network.

In addition, when there is no valid apparatus which can be connected within a range of a mobile ad hoc network and share images, among pieces of apparatus (remote apparatus) existing outside of the mobile ad hoc network, apparatus located in the closest or at a desired location can be exceptionally adopted, and the images of the remote apparatus can be transmitted via a base station or a mediation server. And also the images can be transmitted from the first apparatus, as host apparatus, to the remote apparatus via a base station or a mediation server.

In several other exemplary embodiments, the outside image includes a plurality of the outside images taken from different angles of the first apparatus, and the first display module (200) included in the first apparatus (10) may display a monitoring image of the entire exterior of the first apparatus by combining a plurality of the outside images. In other words, for example, when there are the first apparatus (10) as host apparatus and three pieces of the second apparatus around the first apparatus (10), the first display module (200) can display not only own images received from the first camera module (100) but also three outside images transmitted from the second apparatus.

A sensor module (400) detects the amount of impact applied onto the body of its own, and transmits the message to an event management portion (500). The sensor module (400) may include various compositions which detect the amount of impact applied from the inside or the outside.

In addition, the event management portion (500) delivers own images taken at the time of an accident from the first apparatus (10) to a plurality of the second apparatus (the surrounding apparatus) over a mobile ad hoc network when the sensor portion (20) detects the impact; at this, outside images already received from a plurality of the second apparatus can be transmitted again to the plurality of second apparatus. In other words, since each second apparatus recognizes only the second image transmitted by itself, it can be set up that all the second images generated from the second apparatus can be shared with each other in case of an accident.

In the present description, the term “accident” refers to all kinds of events wherein the impact is detected on the host apparatus or the surrounding apparatus. Or, as previously described, when the impact is detected, only the message or signal about the impact can be transmitted while the images are not repeatedly transmitted as the images have already been shared in realtime. The apparatus which received the message or signal may also extract and deliver the images relative to the accident to the outside.

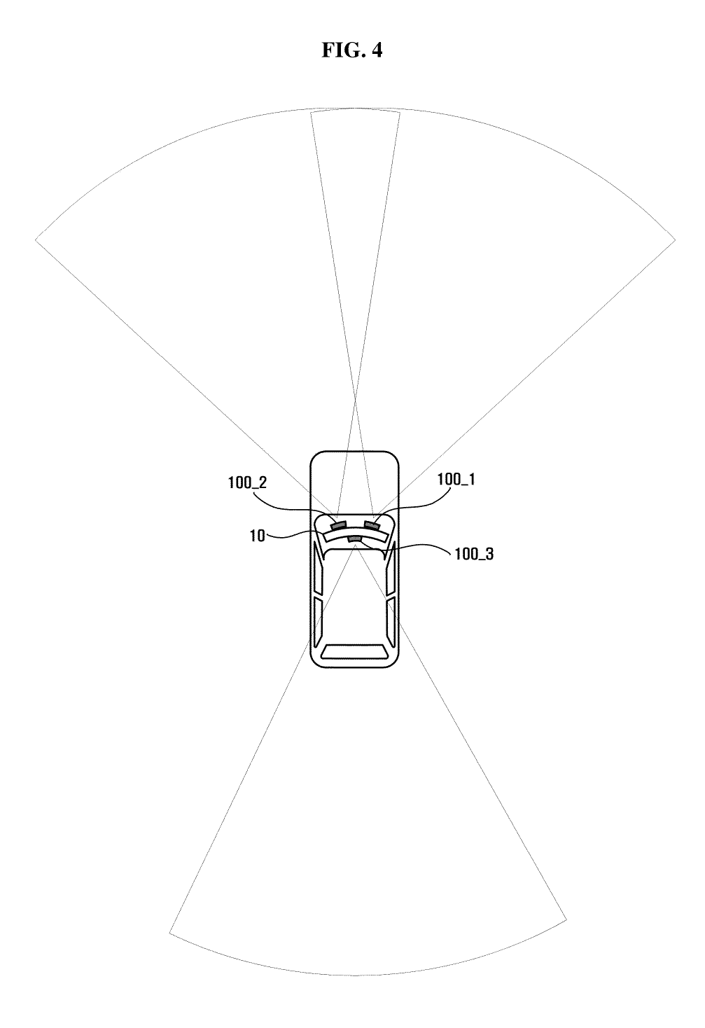

FIG. 2 and FIG. 4 show one exemplary embodiment of the apparatus for sharing network multimedia data in realtime wireless manner for the purpose of extending vision in FIG. 1.

FIG. 2 shows the front portion of the apparatus for sharing network multimedia data in realtime wireless manner for the purpose of extending vision (10) in accordance with one exemplary embodiment of the present invention.

As described, the first apparatus (10) may take a curved form which can enhance the efficiency of shooting of the front area but its form is not limited thereto and may take a flat form.

In the front portion, a plurality of the first camera modules (100_1, 100_2) for taking images of the front area can be located and they may be placed at different angles from each other to minimize the blind spot of shooting. In the described exemplary embodiment, two of the first camera modules (100_1, 100_2) can be located in the front area but their location is not limited thereto and more camera modules can be located in a certain area of the first apparatus (10).

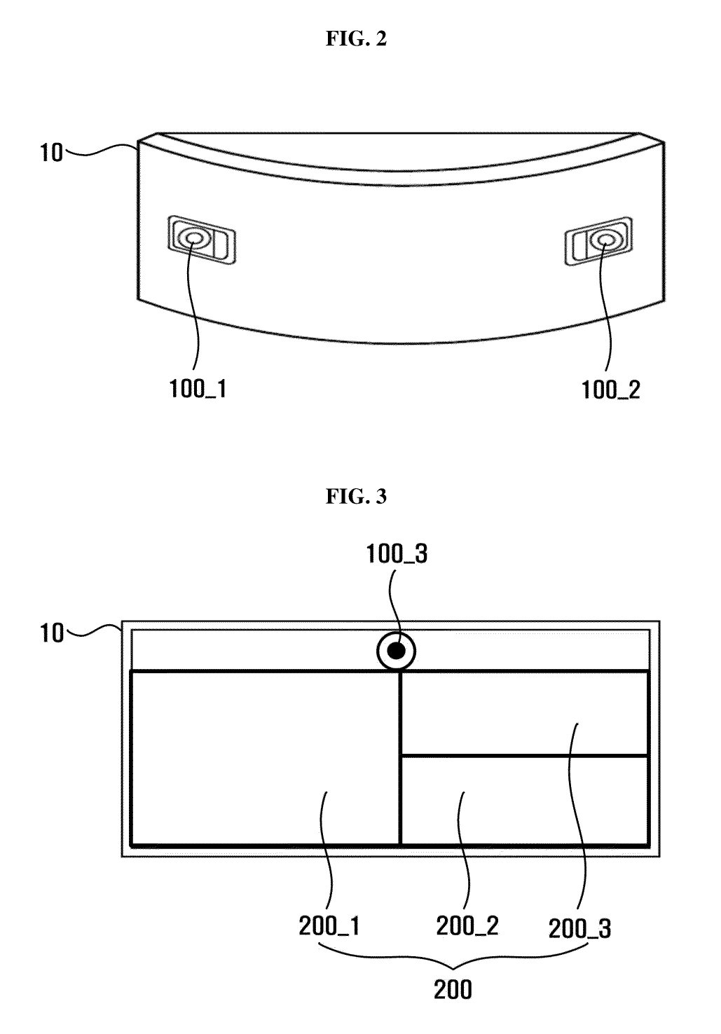

The FIG. 3 shows the rear portion of the first apparatus (10).

As illustrated, one of the first camera modules (100) for taking rear images can be located in the rear portion but its location is not limited thereto and two or more camera modules can be placed. As in the front portion, the rear portion may take a curved form but its form is not limited thereto and may include a flat shape.

In addition, the first display module (200) that displays a plurality of own images taken by the plurality of first camera modules (100_1 or 100_3) can be located in the rear portion. The first display module (200) may be a flexible display panel corresponding to the shape of the rear portion or a flat display panel. When the first display module (200) has a curved shape, more information can be displayed as the image output area is expanded more when compared with a flat display panel.

In this exemplary embodiment, the first display module (200) may display all of three own images taken by three units of first camera modules (100_1 or 100_3) or only the selected own image.

To this end, the first display module (200) may include three sub-display modules (200_1 or 200_3) that split and display three own images but it is not limited thereto.

As illustrated in several other exemplary embodiments, the first apparatus (10) receives outside images from a plurality of surrounding second apparatus and further displays multiple outside images on the first display module (200). For example, the first sub-display module (200_1) collects and displays rear images from the first camera module (100_3) that takes the rear image of the first apparatus (10) and selects the rear image of the second apparatus among the outside images received from the second apparatus located at the back of the first apparatus and displays them on the second sub-display module (200_2).

Therefore, the first vehicle with the first apparatus (10) can detect the second vehicle located at the back of it and obtain extended vision by collecting more rear images from the second vehicle.

FIG. 4 shows a viewing angle for shooting of the vehicle having the apparatus for sharing network multimedia data in realtime wireless manner for the purpose of extending vision (10) in accordance with exemplary embodiments of the present invention.

As described, the first apparatus (10) located inside a vehicle takes the front and rear circumstances adjacent to the vehicle by using a plurality of first camera modules (100_1 or 100_3) but it is not limited thereto and can obtain own images of the left and right sides, depending on the angle and number of camera modules located.

In this exemplary embodiment, two of the first camera modules (100_1, 100_2) that are located in the front can be placed at a prescribed distance away from each other on both sides of the first apparatus (10) and have different shooting angles. Therefore, the first camera module (100_2) located on the left side of the vehicle and the first camera module (100_1) located on the right side of the vehicle can take front images from different angles but they can be located in a way that they can have partially overlapped shooting angles as in this exemplary embodiment.

Therefore, the blind spot of shooting can be minimized by having two or more cameras to take images of the front and rear areas that have a significant influence on driving information while a vehicle is moving and when a certain camera module is malfunctioning or cannot take normal own images due to obstructed views caused by outside impact, for example, an accident, own images taken by the rest of the camera modules can make up for the malfunctioning camera module.

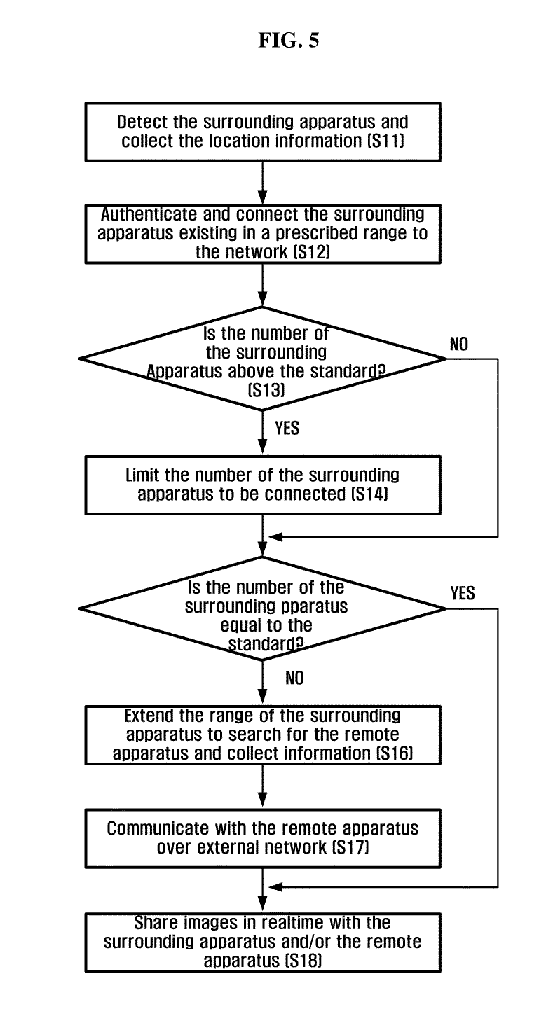

FIG. 5 is a flow chart that explains a method to form a mobile ad hoc network group among pieces of apparatus for sharing network multimedia data in realtime wireless manner for the purpose of extending vision in accordance with another exemplary embodiment of the present invention.

The apparatus comprising the system for sharing network multimedia data in realtime wireless manner for the purpose of extending vision will be hereinafter referred to as network multimedia apparatus.

The host apparatus (the body), comprising the system for sharing network multimedia data in realtime wireless manner for the purpose of extending vision in accordance with the exemplary embodiments of the present invention, detects apparatus around itself either in motion or static, and collects the location information of the relevant apparatus (S11) by using the first communication module. Then, it checks whether the detected apparatus (the second communication module) is within a prescribed range, and authenticates and connects the apparatus over the network (S12). The range can vary depending upon the kind of network. When the mobile ad hoc network is used, the range can be determined in consideration of the range of data transmission or traffic. In addition, the number of nodes connected on the network can be restrictive. That is, the number of the surrounding apparatus arranged in front of the host apparatus and that of the surrounding apparatus arranged in the rear of the host apparatus can be restrictive. For example, one piece of surrounding apparatus can be arranged in front of the host apparatus, and two or three of pieces of surrounding apparatus can be arranged in the rear. That is, the number of total apparatus including the host apparatus and the surrounding apparatus which share images in realtime on a single network can be limited to four or five.

Moreover, in case the number of the surrounding apparatus detected is above the prescribed number as a standard, the number of the connected surrounding apparatus can be limited to a standard (S14) in overall consideration of the order of shortest distance, the condition of network connection, and the preferred location.

Then the host apparatus determines whether the number of the surrounding apparatus is equal to a standard (S15), and if so, can share images in realtime with the surrounding apparatus (S18).

On the other hand, in case the number of the surrounding apparatus is below the standard, the range of the surrounding apparatus can be extended to search remote apparatus and the data thereof can be collected (S16). And, the host apparatus can communicate with the remote apparatus over an external network (S17), for example, a base station for mobile communication, mediation server, repeater, and sharing device, wherein the host apparatus can share images in realtime with the surrounding apparatus and/or the remote apparatus (S18).

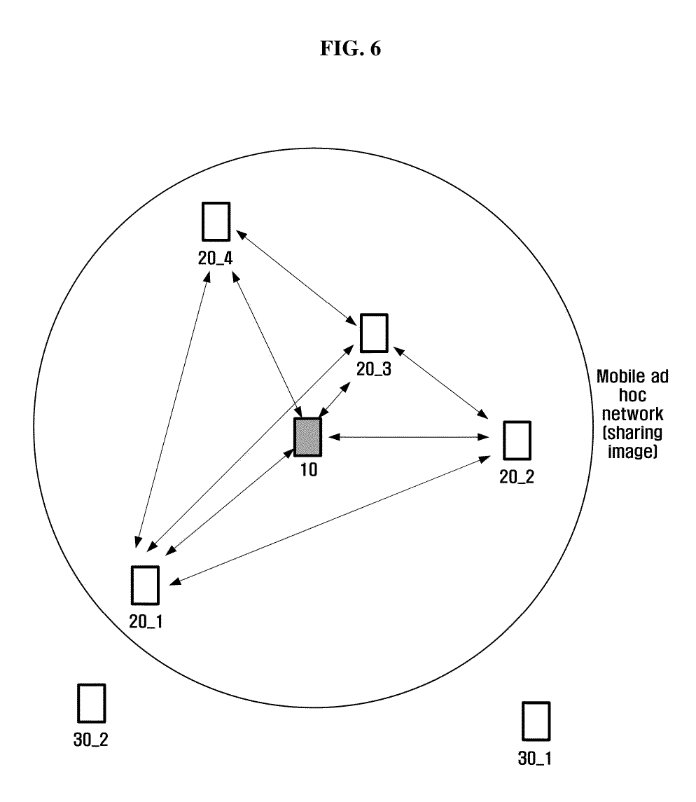

FIG. 6 shows the relationship between multiple pieces of apparatus that are connected on a mobile ad hoc network in FIG. 5.

A mobile ad hoc network can be set up within a prescribed range from the first vehicle (10), the host apparatus, and surrounding vehicles (20_1, 20_2, 20_3, 20_4; hereinafter referred to as 200) existing on the network can share specific images not only with the first apparatus (10) but also with each other. Such images can be shared as a result of specific events or images can be received from other apparatus and displayed on a regular basis.

As shown in the drawing, since not only the front and rear images of the first vehicle (10) but also those of the surrounding vehicles (20_3, 20_4) located in front of the first vehicle (10), and of the surrounding apparatus (20_1, 20_2) located behind the first vehicle (10) are shared with each other, a clear view can be secured by checking the rear image of the surrounding vehicles (200_1, 200_2) located in the rear, or the front image of the surrounding vehicles 20_3, 20_4) located in the front, which are difficult to be seen from the first vehicle (10), the host vehicle.

As previously described, the first vehicle (10) and the second vehicle that is surrounding vehicle (200) can serve as apparatus in various forms which transceives data over network.

Although non-surrounding vehicles (30_1, 30_2) existing outside a mobile ad hoc network are not connected with the first vehicle (10) and cannot share images over the mobile ad hoc network, they can share images with each other by means of communications other than mobile ad hoc network, such as mobile or broadband.

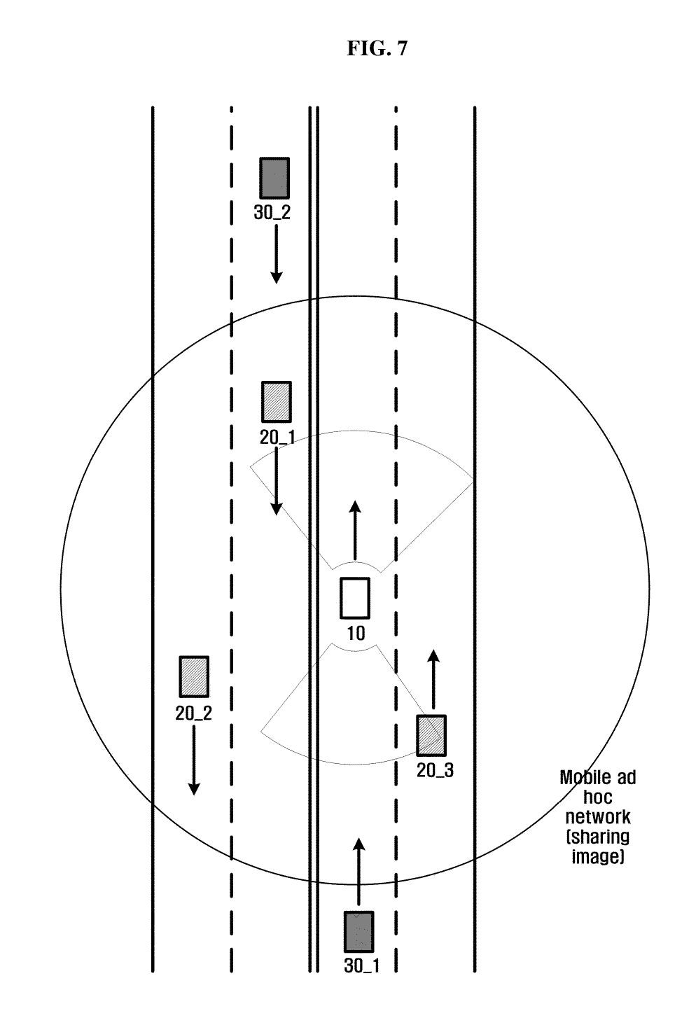

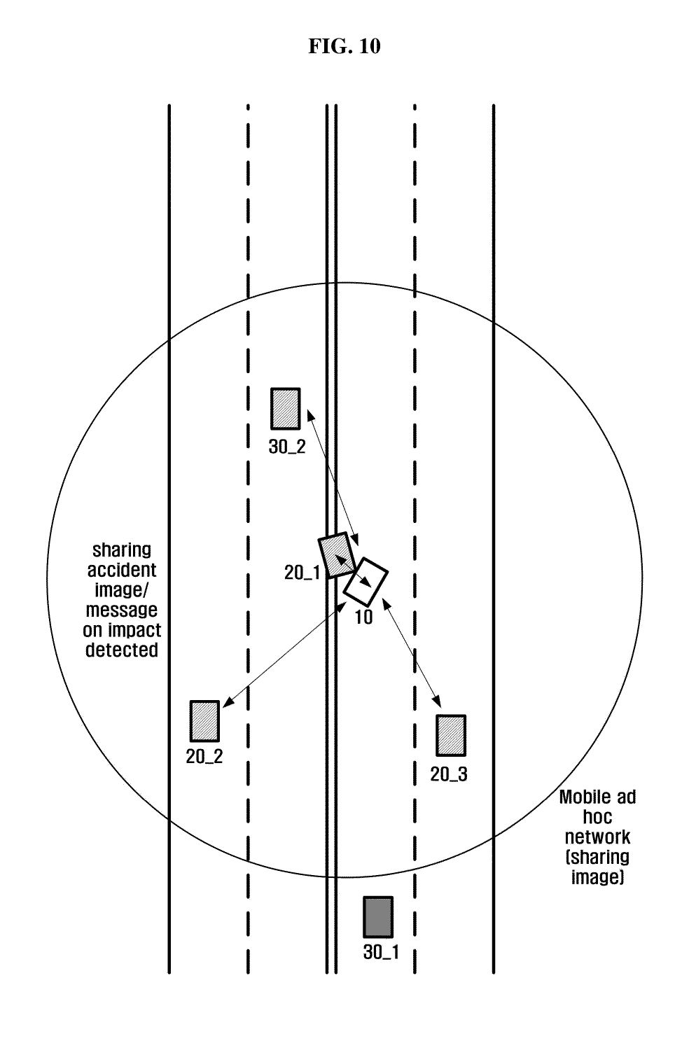

FIG. 7 or FIG. 10 shows a process of sharing multimedia data in realtime at the time of collision between pieces of apparatus for sharing network multimedia data in realtime wireless manner for the purpose of extending vision in accordance with exemplary embodiments of the present invention.

As described above, the apparatus for sharing network multimedia data in realtime wireless manner for the purpose of extending vision in accordance with exemplary embodiments of the present invention can have the same meaning as a vehicle.

As described in FIG. 7, the first vehicle (10) can be connected over a mobile ad hoc network with not only the surrounding vehicle (20_3) that moves in the same direction of the first vehicle but also the surrounding vehicle (20_1, 20_2) that moves in the opposite direction of the first vehicle (10).

In addition, the first vehicle (10) takes the front and rear images of the vehicle by using a plurality of camera modules and own images taken can be shared with surrounding vehicles (20_1, 20_2, 20_3) in realtime. Although it is not described, surrounding vehicles (20_1, 20_2, 20_3) also share outside images taken from each of the surrounding vehicles with the vehicles existing on the same mobile ad hoc network.

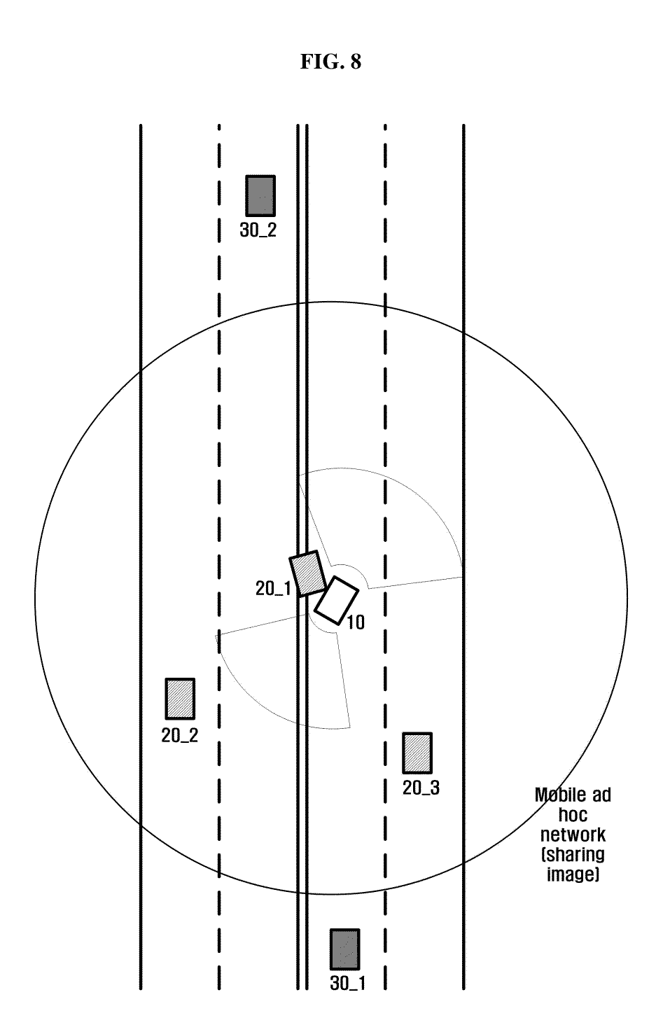

As illustrated in FIG. 8, the first vehicle (10) on the move may face collision, for example a car accident, with the surrounding vehicle (20_1) that is moving from the opposite direction.

At this moment, own images that are being taken by the first vehicle (10) can be shared with surrounding vehicles (20_1, 20_2, 20_3) over an ad hoc network in order to identify the cause of the accident. However, if the first vehicle (10) and the surrounding vehicle (20_1) that collides with the first vehicle (10) collide with each other in the blind spot of shooting of the first vehicle (10) or if a camera module is damaged by the collision, the first vehicle (10) may not be able to obtain accurate images at the time of collision.

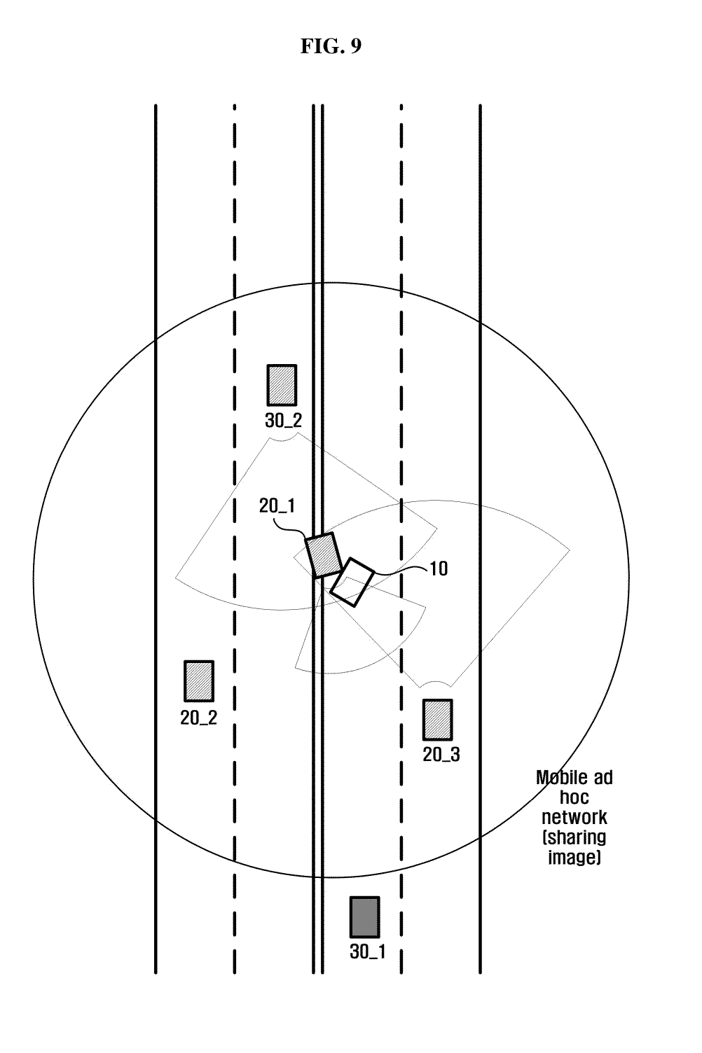

As described in FIG. 9, although the first vehicle (10) cannot take images at the time of the accident, images of the first vehicle (10) and the surrounding vehicle (20_1) that collides with it can be taken by the surrounding vehicle (20_1) that collides with the first vehicle and the surrounding vehicle (20_3) that follows the first vehicle (10).

Meanwhile, in FIG. 8, the non-surrounding vehicle (30_2) outside the range of a mobile ad hoc network enters the range of the mobile ad hoc network of the stopped first vehicle (10) after the accident to become an additional participant in the ad hoc network formed around the first vehicle (10). Therefore, the first vehicle can obtain not only the outside images taken by the surrounding vehicles (20_1, 20_2, 20_3) but also the outside images taken by the non-surrounding vehicle (30_2).

By doing so, the first vehicle (10) can make up for the lack of images at the time of the accident, which cannot be obtained by its own images, by using the outside images shared with the surrounding vehicles connected over a mobile ad hoc network and the surrounding vehicles can obtain diverse images at the time of the accident in realtime.

In addition, the collision location and the degree of damage of the first vehicle (10) can be identified objectively by combining the images of the first vehicle (10) taken from different angles by the surrounding vehicles.

In reference with FIG. 10, in case the first vehicle (10) and the other vehicle (20_1) collide, and the impact is detected on the first vehicle (10), the first vehicle (10) can transmit the black box images taken before and after the collision to the surrounding vehicles (20_2, 20_3) existing on the mobile ad hoc network in order to share the images of the accident. Although not shown in the drawing, the other vehicle (20_1) in the accident also transmits the images to the surrounding vehicles (20_2, 20_3) connected on the mobile ad hoc network and images can be shared between the colliding vehicles.

In addition, when the first vehicle (10) and the other colliding vehicle (20_1) collide, the event management portion generates an accident message and sends it to the surrounding vehicles. Also, event data can be generated to save the images at the time of the accident separately or give separate additional data to the images.

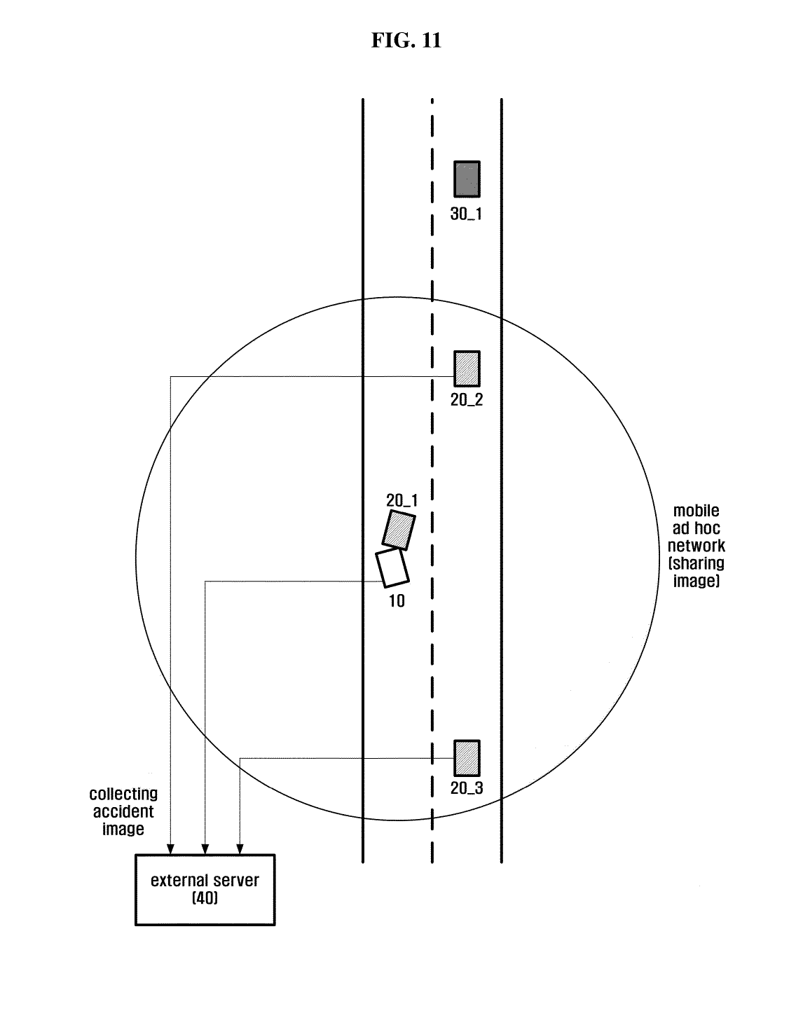

In reference with FIG. 11, the communication module of the surrounding vehicles (20_2, 20_3) or the first vehicle (10) transmits the accident report data including the own image or the outside image to an external server (40), and the external server (40) collects such images of an accident. For example, the external server (40) can be arranged in the place related to a vehicle such as an insurance company, police station or hospital. The external server (40), by collecting images from various angles for a single accident, contributes to the improvement of reliability and accuracy of judgment.

It is clearly understandable for those having ordinary skill in the art the present invention can be embodied in various forms, other than the exemplary embodiments set forth herein, without changes in its technical idea or essential characteristic. The exemplary embodiments described herein are only for the purpose of exemplifying the present invention in all aspects, not of limiting the scope of the present invention.

### DESCRIPTION FOR MARKS

10: apparatus for sharing network multimedia data in realtime wireless manner for the purpose of extending vision
100: first camera module
200: first display module
300: first communication module
400: sensor module
500: event management portion

1. Apparatus for sharing network multimedia data in realtime wireless manner for the purpose of extending vision, including a plurality of first camera modules that take images of outside condition around the first vehicle; a first display module that displays one or more images among multiple own images taken by the plurality of first camera modules; and a first communication module that is connected on a mobile ad hoc network and transmits the own image to multiple second communication modules connected on the same mobile ad hoc network, wherein, the first communication module receives first outside images from the multiple second communication modules and the first display module further displays the outside images.

2. According to claim 1,
Apparatus for sharing network multimedia data in realtime wireless manner for the purpose of extending vision, wherein
the first outside image is taken by the second camera module located in the second vehicle existing on the same mobile ad hoc network area and the second vehicle includes the second communication module and the second display module.

3. According to claim 1,
Apparatus for sharing network multimedia data in realtime wireless manner for the purpose of extending vision, wherein
the first outside image includes multiple vehicle images of the first vehicle taken from different angles, and
the first display module further displays entire exterior monitoring images of the first vehicle by combining the multiple vehicle images.

4. According to claim 1,
Apparatus for sharing network multimedia data in realtime wireless manner for the purpose of extending vision, wherein
the first display module further displays the second outside images taken outside the same mobile ad hoc network range and
the second outside image is transmitted to the first communication module over an external network.

5. According to claim 1,
Apparatus for sharing network multimedia data in realtime wireless manner for the purpose of extending vision, wherein
the sensor module that detects the amount of impact applied onto the first vehicle; and an event management portion that generates event data at the time of an accident when the sensor module detects impact are included.
